(19) United States
(12) Patent Application Publication
(10) Pub. No.: US 2012/0019012 A1
(43) Pub. Date: Jan. 26, 2012

(54) LATCH DEVICE

(75) Inventors: Norio Saito, Kanagawa (JP); Kazuyuki Tomioka, Kanagawa (JP)

(73) Assignee: NIFCO INC., Yokohama-shi (JP)

(21) Appl. No.: 13/138,393

(22) PCT Filed: Feb. 16, 2009
(86) PCT No.: PCT/JP2009/052583

§ 371 Date: Oct. 3, 2011

(51) Int. Cl. E05C 5/02

(52) U.S. Cl. 292/68

(57) ABSTRACT

To obtain a latch device for obtaining a great output load with a small input load.

Holding parts (70) are provided on one end of holding members (64), and cam parts (72) are provided on the other end of the holding members (64), with a support part (68) of the holding members (64) as reference, and the cam parts (72) are moved away from each other by way of a rod (74), whereby the holding parts (70) are moved closer to each other. That is, the magnitude of the external force acting on the cam parts (72) can be changed by the movement of the rod (74), and the holding force of the holding parts (70) can therefore be changed with the support part (68) as a fulcrum. In other words, the stroke of the rod (74) and the position of the support part (68) of the holding member (64) are changed, and the distance from the support part (68) to the holding part (70) is made longer than the distance from the support part (68) to the cam parts (72).

### TECHNOLOGICAL FIELD

The present invention relates to a latch device for holding a held body.

### BACKGROUND TECHNOLOGY

In a moving mechanism for moving a sliding door fitted into a door frame for a prescribed distance, a catcher (latch device) for holding a striker (contacted body) provided on the door frame is provided so that the sliding door is moved by way of the catcher.

For example, in Patent Document 1, a catcher stopper provided to be capable of moving up and down inside the catcher is insertable into a latch hole, and the catcher is locked in this state. Also, when the striker enters into the catcher, the striker is pushed against a side wall of a case; the catcher closes and the striker is held therewith; the catcher moves up and down by way of guide troughs provided on the catcher and the catcher stopper; and the locked state with the latch hole is released. The movable body is thereby moved by an impelling mechanism by way of the catcher.

However, in this Patent Document 1, the catcher stopper must be moved upward in order for the catcher stopper to come out from the latch hole. On the other hand, an external force in the horizontal direction is always applied to the catcher stopper by the impelling mechanism by way of the catcher.

### DISCLOSURE OF THE INVENTION

### Problem to be Solved by the Invention

The present invention is to provide a latch device for obtaining a great output load with a small input load.

### Means for Solving the Problem

In a first aspect of the present invention, there is provided a latch device, comprising: a pair of holding members provided with holding parts capable of holding a striker; a support part for supporting said holding parts to be capable of moving closer and moving away; contacted parts provided on said holding members and positioned on sides opposite said holding parts with said support part as a reference; a rod provided to be capable of moving between the pairs of said holding parts and said contacted parts; an impelling member for impelling said rod toward said holding parts; and contacting parts projecting from an outer perimeter surface of said rod to contact said contacted parts, so that said contacted parts are moved in a direction of moving away from each other and said holding parts are moved in a direction of moving closer to each other when the rod is moved in a direction opposing the impelling force of said impelling member.

The abovementioned aspect has a pair of holding members provided with holding parts .capable of holding a striker. These holding members are supported by a support part, and the holding parts are capable of moving closer and moving away. Also, contacted parts are provided on sides opposite said holding parts with the support part as a reference, and a rod is provided to be capable of moving between the pairs of holding parts and contacted parts.

The rod is impelled toward the holding part by an impelling mechanism. Also, contacting parts for contacting the contacted parts project from an outer perimeter surface of the rod, and when the rod is moved in a direction opposing the impelling force of the impelling member, the contacted parts are moved in a direction of moving away from each other and the holding parts are moved in a direction of moving closer to each other, and the striker is held by the holding part.

Here, the holding parts are provided on the side of one end of the holding members and the contacted parts are provided on the side of the other end of the holding members with the support part as a reference, so that the holding parts are moved closer to each other as the contacted parts are moved away from each other by way of the rod. The magnitude of the external force acting on the contacted parts can thereby be changed by the movement of the rod, and the external force moving the contacted parts away from each other can therefore be transformed into a holding force of the holding parts with the support part as a fulcrum.

In other words, the stroke of the rod and the position of the support part of the holding member are changed, and a great holding force can thereby be obtained with a small force utilizing the principle of a lever.

In a second aspect of the present invention, an inclined cam surface for transforming an amount of movement of said rod into a rotational force for moving said holding parts closer may be formed on said contacted part or said contacting part in the first aspect of the present invention.

In the abovementioned aspect, an inclined cam surface is formed on the contacted part or the contacting part, so that the amount of movement of the rod is transformed into rotational force of the holding member and the holding parts are moved closer. In other words, when the rod is pushed in the axial direction, the holding parts are moved closer and the striker is held.

In a third aspect of the present invention, a distance from said support part to said holding part may be made longer than a distance from the support part to a part of said contacted part contacted by said contacting part in the first aspect of the present invention.

In the abovementioned aspect, the distance from the support part to the holding part is made longer than the distance from the support part to the part of the contacted part contacted by the contacting part, so that a great holding force is thereby obtained with a small force utilizing the principle of a lever.

In a fourth aspect of the present invention, a projecting part projecting in the direction of moving away to be caught in a hole part formed on a latch case, on which said support part is installed, in a state in which said striker is held by said holding part, may be provided on an end part of said contacted part in the first aspect of the present invention.

In the abovementioned aspect, the projecting part is provided on the end part of the contacted part, so that the projecting part is caught in the hole part formed on the latch case in a state in which the striker is held by the holding part, so that the holding member does not rattle.

### Effect of the Invention

Because the present invention is constituted as above, a great holding force can be obtained with a small force.

### BRIEF DESCRIPTION OF THE DRAWINGS

FIG. 1A is an explanatory drawing illustrating the operation of a sliding door using a moving apparatus in which the latch device of the present mode of working is applied;

FIG. 1B is an explanatory drawing illustrating the operation of the sliding door using the moving apparatus in which the latch device of the present mode of working is applied;

FIG. 2 is a generalized exploded perspective view of the moving apparatus in which the latch device of the present mode of working is applied;

FIG. 3 is a generalized sectional view of the moving apparatus in which the latch device of the present mode of working is applied;

FIG. 4A is a perspective view illustrating the latch device of the present mode of working, illustrating the state in which the holding member is open;

FIG. 4B is a perspective view illustrating the latch device of the present mode of working, illustrating the state in which the holding member is closed;

FIG. 5A is a plan view illustrating the latch device of the present mode of working, illustrating the state in which the holding member is open;

FIG. 5B is a plan view illustrating the latch device of the present mode of working, illustrating the state in which the holding member is closed;

FIG. 6A is a generalized plan view corresponding to FIG. 1A, illustrating. the upper part of the case of the moving apparatus in which the latch device of the present mode of working is applied, and FIG. 6B is a generalized sectional view corresponding to FIG. 1A, illustrating the lower part of the case of the moving apparatus in which the latch device of the present mode of working is applied;

FIG. 7A is a generalized plan view corresponding to FIG. 1B, illustrating the upper part of the case of the moving apparatus in which the latch device of the present mode of working is applied, and FIG. 7B is a generalized sectional view corresponding to FIG. 1B, illustrating the lower part of the case of the moving apparatus in which the latch device of the present mode of working is applied;

FIG. 8A is an explanatory drawing illustrating the operation of a sliding door using the moving apparatus in which the latch device of the present mode of working is applied;

FIG. 8B is an explanatory drawing illustrating the operation of a sliding door using the moving apparatus in which the latch device of the present mode of working is applied;

FIG. 8C is an explanatory drawing illustrating the operation of a sliding door using the moving apparatus in which the latch device of the present mode of working is applied;

FIG. 9A is a generalized plan view corresponding to FIG. 8A, illustrating the upper part of the case of the moving apparatus in which the latch device of the present mode of working is applied, and FIG. 9B is a generalized sectional view corresponding to FIG. 8A, illustrating the lower part of the case of the moving apparatus in which the latch device of the present mode of working is applied;

FIG. 10A is a generalized plan view corresponding to FIG. 8B, illustrating the upper part of the case of the moving apparatus in which the latch device of the present mode of working is applied, and FIG. 10B is a generalized sectional view corresponding to FIG. 8B, illustrating the lower part of the case of the moving apparatus in which the latch device of the present mode of working is applied; and

FIG. 11A is a generalized plan view corresponding to FIG. 8C, illustrating the upper part of the case of the moving apparatus in which the latch device of the present mode of working is applied, and FIG. 11B is a generalized sectional view corresponding to FIG. 8C, illustrating the lower part of the case of the moving apparatus in which the latch device of the present mode of working is applied.

### MODE OF WORKING OF THE INVENTION

A moving apparatus for a moving body in which the latch device of the present mode of working is applied is next described.

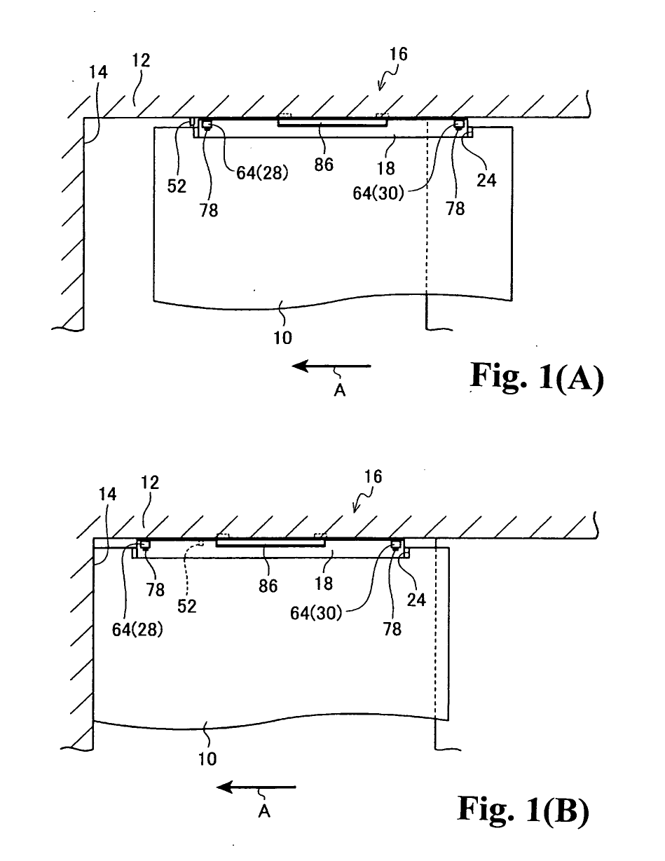

A sliding door 10 as a movable body is illustrated in FIGS. 1A and 1B, and is capable of moving horizontally following rails (not illustrated) provided above and below a door frame 12 as a frame body. An opening 14 inside the door frame 12 is closed or opened by movement of this sliding door 10. Here, a moving apparatus 16 is provided at the center of the upper end part of this sliding door 10.

### (Constitution of the Moving Apparatus)

The moving apparatus is described here.

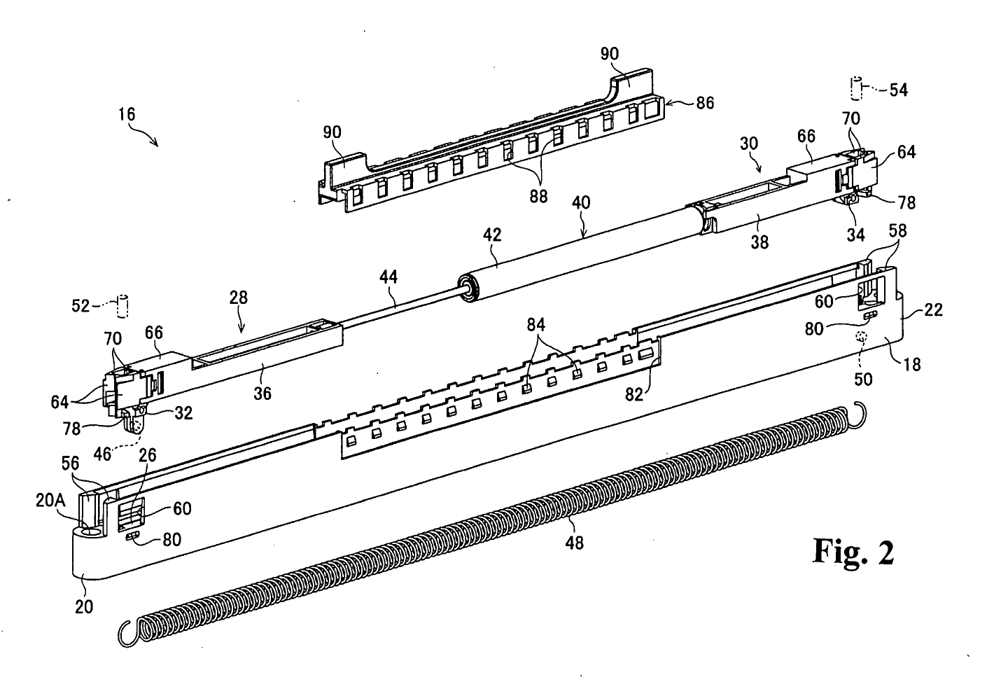

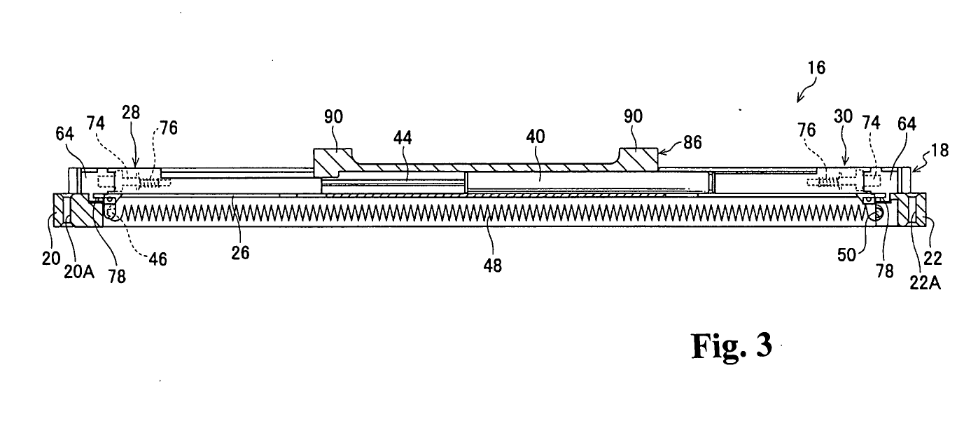

As illustrated in FIGS. 2 and 3, the moving apparatus 16 has a roughly box-shaped case 18. Installation parts 20 and 22 are provided at the lower part in the height direction of the case 18 on both end parts in the lengthwise direction of the case 18, and insertion holes 20A and 22A, into which fastening screws not illustrated are insertable, are respectively formed in the center parts of the installation parts 20 and 22.

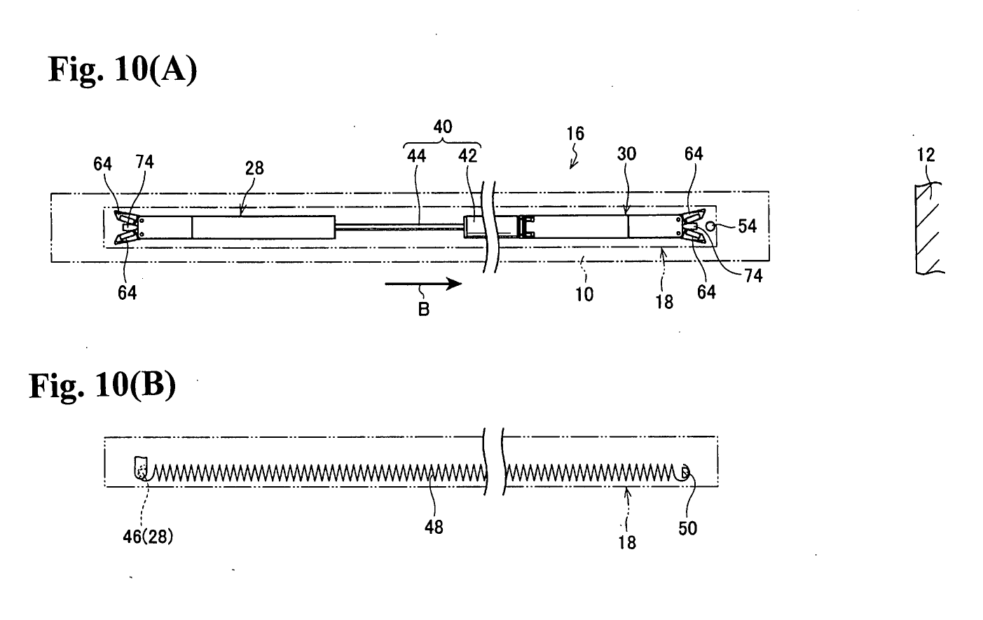

The case 18 is received in a receiving cavity 24 (see FIG. 1) provided on the upper end surface of the sliding door 10 (see FIG. 10), the fastening screws are inserted into the insertion holes 20A and 22A, the fastening screws are screwed into the floor part of the receiving cavity 24, and the case 18 is thus fastened to the sliding door 10.

Also, a pair of rails 26 is provided following the lengthwise direction of the case 18, on the inner wall surface of the case 18 at the center part in the height direction of the case 18. Latch units (latch devices) 28 and 30 disposed on both ends in the lengthwise direction of the case 18 are mounted on these rails 26.

The latch units 28 and 30 are constituted with sliders 36 and 38 that slide inside the case 18 following the rails 26, and latch cases (holding mechanisms) 66 provided on the end parts of the sliders 36 and 38.

Also, stopping pieces 32 and 34 for preventing the sliders 36 and 38 from coming off are respectively provided on the lower parts of the sliders 36 and 38, to be positioned at the lower part in the height direction of the case 18 and exposed from the lower part of the rail 26. The rail 26 can be held between the sliders 36, 38 and the stopping pieces 32, 34. Also, when the latch units 28 and 30 move inside the case 18, the latch units 28 and 30 move inside the case 18 by way of the sliders 36 and 38 so as not to rattle.

Also, a damper (damping mechanism) 40 is provided between the slider 36 and the slider 38. The damper 40 has a cylinder 42, and a viscous fluid is filled inside the cylinder 42. Also, a piston (not illustrated) is provided inside the cylinder 42, and is capable of moving reciprocally inside the cylinder 42. The volume of the viscous fluid is compressed by this piston, so that a damping force acts on a piston rod 44 provided on the piston.

The piston rod 44 is connected to the slider 36, the cylinder 42 is connected to the slider 38, and the speed of movement during movement of the slider 36 (latch unit 28) or the slider 38 (latch unit 30) is damped.

Here, an example is given of a damper 40 constituted with a cylinder 42 and a piston, but the damper is not particularly limited, because it is sufficient to be capable of damping the movement speed of the slider 36 (latch unit 28) or the slider 38 (latch unit 30). For example, the damper may be constituted with a latch and a damper gear.

Meanwhile, a connecting part 46 is provided on the lower part of the stopping piece 32 on the side of the latch unit 28, and one end part is connected to a tension spring (impelling mechanism) 48. A connecting part 50 is provided on the side of the installation part 22 of the case 18, and the other end part of the tension spring 48 is connected to this connecting part 50.

Also, the tension spring 48 becomes in a state in which elastic energy (impelling force) is accumulated in the state in which the latch unit 28 is disposed on the side of the installation part 20 of the case 18 (see FIG. 3). The impelling force of this tension spring 48 is greater than the damping force of the damper 40.

Incidentally, both end parts in the lengthwise direction of the case 18 positioned at the upper part in the height direction of the case 18 are open, and pin members (strikers) 52 and 54 provided on the door frame 12 can be inserted. A pair of guide pieces 56 and 58 is respectively provided on both end parts in the lengthwise direction of the case 18, forming an inclined surface in which the two gradually move closer to each other while going into the case 18. The pin members 52 and 54 are respectively guided assuredly into the latch units 28 and 30 by these guide pieces 56 and 58.

Also, rectangular window holes 60 are respectively formed adjacent to the guide pieces 56 and 58 on the upper part in the height direction of the case 18, and although a description will be given later, holding members 64 provided on the latch units 28 and 30 are capable of projecting to the outside through the window holes 60 in a state (so-called “locked state”) in which the movement of the latch units 28 and 30 against the case 18 is restricted.

Furthermore, a pair of recessed parts 82 for coupling is formed following the lengthwise direction of the case 18 at the center of the upper part in the height direction of the case 18, and a plurality of claw parts 84 is formed at a prescribed distance following the lengthwise direction of the case on the surfaces of the recessed parts 82 for coupling. A cover 86 roughly U-shaped in cross section is capable of coupling inside these recessed parts 82 for coupling.

Rectangular holes 88 in which the claw parts 84 are caught are formed on the side walls of the cover 86. The cover 86 is fitted in from above the recessed parts 82 for coupling, and the claw parts 84 are caught in the rectangular holes 88. In this state, the damper 40 is prevented from coming off, and the damper 40 is prevented from rising up. Also, coupling pieces 90 are respectively formed in the lengthwise direction on the upper surface of the cover 86, and these coupling pieces 90 are coupled with a rail (not illustrated) provided on the door frame 12.

### (Latch Unit)

Here, the latch units 28 and 30 are described. The latch unit 28 and the latch unit 30 only differ by the presence or absence of the connecting part 46 provided on the lower part of the stopping piece 32, and the rest of the constitution is the same. The latch unit 28 is therefore described as representative.

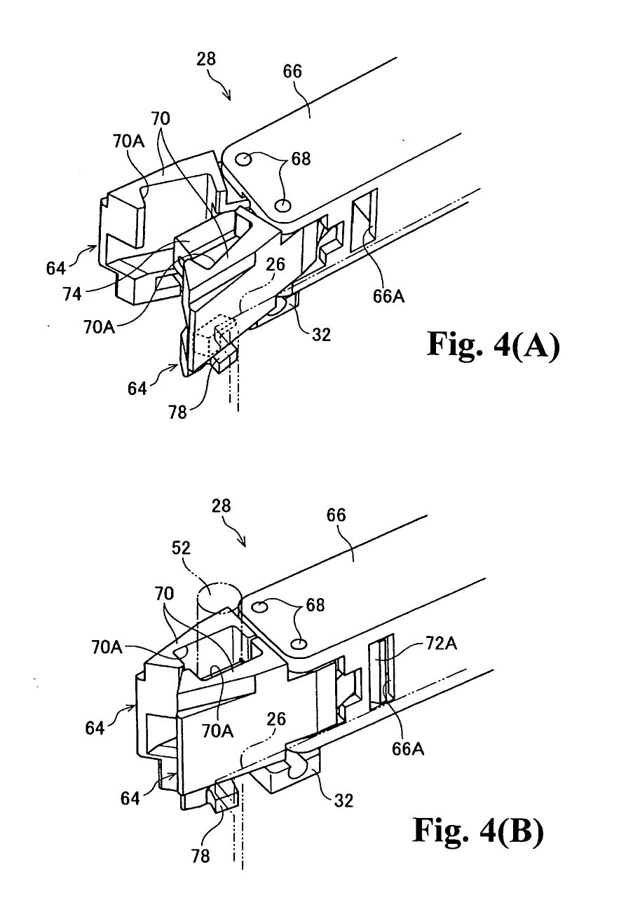

As illustrated in FIGS. 2, 4A, and 4B, a box-shaped latch case 66 is provided on one end part (on the side of the guide piece 56 of the case 18) of the slider 36 constituting the latch unit 28.

A support part 68 is provided following the height direction of the latch case 66, on each end part in the width direction, positioned at one end part (on the side of the guide piece 56 of the case 18) of the latch case 66. A part near the center of the holding member 64 is supported on the support part 68, and the holding member 64 is capable of swaying.

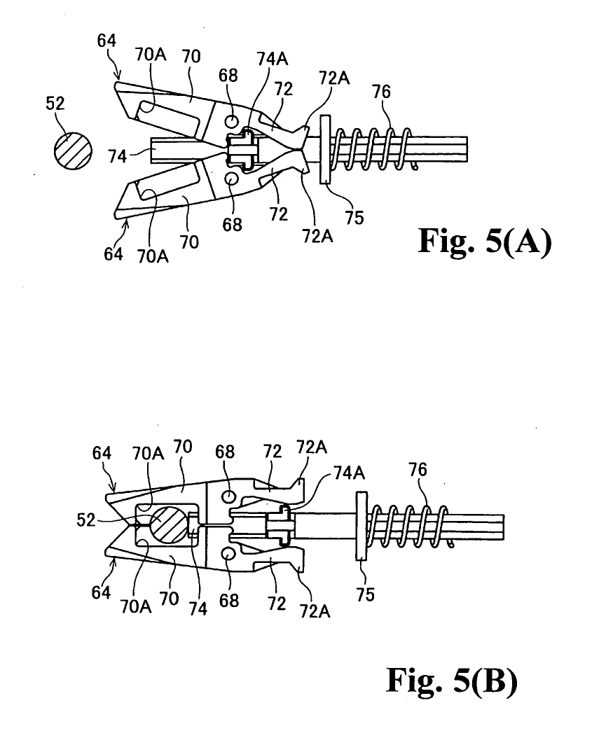

Meanwhile, as illustrated in FIGS. 5A and 5B, the holding member 64 is provided with a holding part 70 for holding the pin member 52 on the side of one end, and is provided with a cam part (contacted part) 72 to be described on the side of the other end. Also, a rod 74 running through the latch case 66 is provided between the holding member 64 and the holding member 64.

This rod 74 is capable of projecting from inside the latch case 66, and is impelled toward the direction of projecting from the latch case 66 by a latch spring 76 provided between the latch case 66 and a stopper 75 formed on the outer perimeter surface of the rod 74.

Also, a contacting part 74A for contacting the cam part 72 of the holding member 64 projects from the outer perimeter surface of the rod 74. As illustrated in FIG. 5A, the holding parts 70 head in a direction of moving away from each other while going in a direction of moving away from the support part 68 in the state in which the holding members 64 are open. Also, the cam parts 72 head in a direction of moving closer to each other while going in a direction of moving away from the support part 68.

Therefore, as illustrated in FIG. 5B, when the rod 74 moves in the direction opposing the impelling force of the latch spring 76, the position of contact of the contacting part 74A to the cam part 72 shifts, and the cam parts 72 move away from each other while the contacting part 74A goes to the front end part of the cam part 72. The holding member 64 is thereby rotated on the support part 68 as a center, and the holding parts 70 move in a direction of moving closer to each other.

In other words, the cam parts 72 are provided on the side of the other ends of the holding members 64, so that the amount of movement of the rod 74 is transformed into a rotational force for rotating the holding members 64 and the holding parts are moved closer to each other. The holding parts 70 are thereby moved closer when the rod 74 is pushed in the axial direction, and the pin members 52 are held.

As above, the holding part 70 is provided on the side of one end of the holding member 64 and the cam part 72 is provided on the side of the other end of the holding member 64 with the support part 68 of the holding member 64 as reference, so that the holding parts 70 are moved closer to each other as the cam parts 72 are moved away from each other by way of the rod 74.

That is, the magnitude of the external force acting on the cam parts 72 can be changed by the movement of the rod 74, and the holding force of the holding parts can be changed with the support part as a fulcrum. In other words, the stroke of the rod 74 and the position of the support part 68 of the holding member 42 are changed, and the distance from the support part 68 to the holding part 70 is made longer than the distance from the support part 68 to the part of the cam part 72 contacted by the contacting part 74A, so that a great holding force is thereby obtained with a small force utilizing the principle of a lever.

Here, as illustrated in FIG. 4A, a recessed part 70A for coupling is formed on the side of the upper surface of the holding part 70 in a state having a hollowed-out inner surface, so that a gap is provided between the holding part 70 and the holding part 70. The pin member 52 is capable of coupling in this gap.

Meanwhile, the side of the lower surface of the holding part 70 is substantially not provided with a gap in the state in which the holding members 64 are closed. The front end part of the pin member 52 is received by the lower surface part of the holding part 70 in the state in which the pin member 52 is coupled in the holding part 70, so that there is no rattling between the pin member 52 and the holding member 64.

Also, as illustrated in FIGS. 5A and 5B, a projecting part 72A projecting outward is provided on the front end part of each cam part 72. Meanwhile, as illustrated in FIGS. 4A and 4B, an insertion hole (hole part) 66A is formed on the side wall of the latch case 66, and the projecting part 72A is inserted into the insertion hole 66A in the state in which the holding members 64 are closed, so that the holding members 64 do not rattle in the state in which the pin member 52 is held by the holding members 64.

Incidentally, a catching piece 78 positioned at the lower part in the height direction of the case and exposed from the lower part of the rail 26 is provided on the lower part of the holding member 64. The rail 26 provides a gap with the installation part 20 (see FIG. 3), and as illustrated in FIG. 4A, the catching piece 78 is caught on the front end part of the rail 26 in the state in which the holding members 64 are open. At this time, the holding member 64 projects outward through the window hole 60.

Here, as illustrated in FIG. 2, a catching hole 80 is formed at a part below the window hole 60 on the case 18, and the front end part of the catching piece 78 is inserted into the catching hole 80 in the state in which the catching piece 89 is caught on the front end part of the rail 26. The latch unit 28 is locked in this state.

Also, the pin 52 contacts the rod 74 of the latch unit 28, and the rod 74 is pushed in the direction opposing the impelling force of the latch spring 76, at which time the holding members 64 close as illustrated in FIG. 4B, but at this time, the front end part of the catching piece 78 comes out from the catching hole 80, and the catching piece 78 is released (so-called “unlocked”) from the state of being caught with the front end part of the rail 26.

### (Operation of the Moving Apparatus)

The operation of the moving apparatus in which the latch device according to the present mode of working is applied is next described.

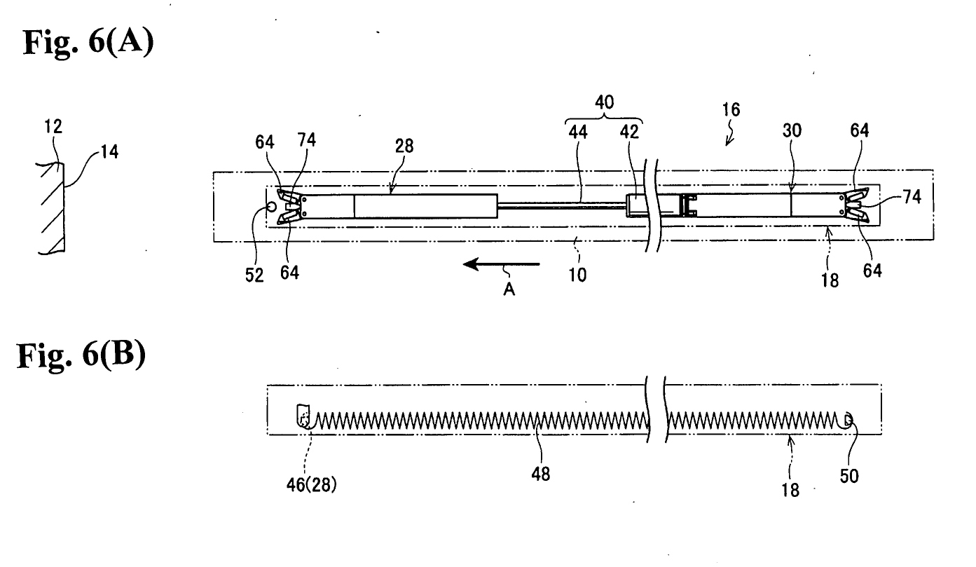

The sliding door is moved in the direction of closing (direction of arrow A) as illustrated in FIGS. 1A, 6A, and 6B. FIG. 6A is a generalized drawing in plan view corresponding to FIG. 1A illustrating the upper part of the case 18, and FIG. 6B is a generalized drawing in sectional view corresponding to FIG. 1A illustrating the lower part of the case 18.

The guide piece 56 (see FIG. 2) of the moving apparatus 16 passes by the pin member 52, and as illustrated in FIGS. 5A and 5B, the pin member 52 contacts the rod 74 of the latch unit 28, and the rod 74 is pushed in the direction opposing the impelling force of the latch spring 76, at which time the cam parts 72 of the holding members 64 are pushed wider by the movement of the contacting parts 74A provided on the rod, and are moved away from each other. The holding members 64 are thereby rotated on the support part 68 as a center, the holding members 64 close, the holding parts 70 are moved closer to each other, and the pin member 52 is held.

At this time, the front end part of the catching piece 78 illustrated in FIG. 4A comes out from the catching hole 80 (see FIG. 2), and the catching piece 78 is released (unlocked) from the state of being caught with the front end part of the rail 26. Because the state in which the latch unit 28 is locked is a state in which elastic energy (impelling force) of the tension spring 48 is accumulated as illustrated in FIG. 6B, the impelling force of the tension spring 48 acts when the latch unit 28 is unlocked.

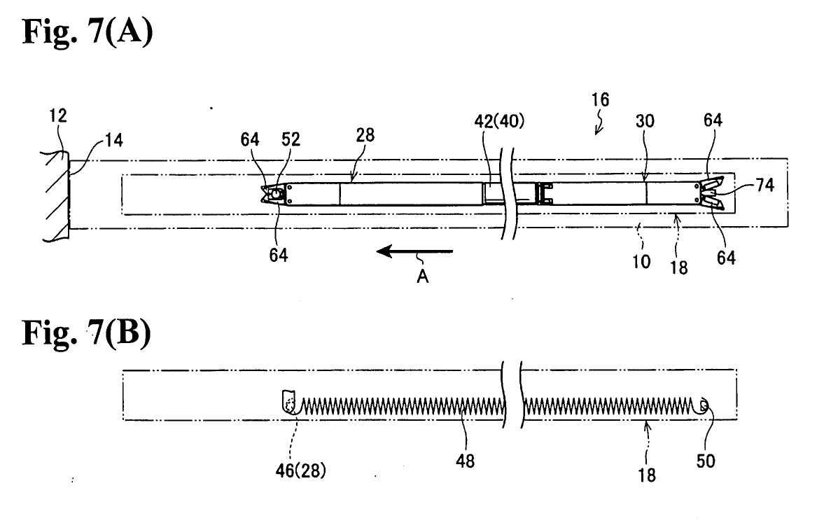

Because the movement of the latch unit 28 is restricted by the pin member 52, the impelling force of the tension spring 48 comes to act on the case 18 as illustrated in FIGS. 1B, 7A, and 7B. In other words, the case 18 is moved in the direction of arrow A based on the latch unit 28, and the sliding door 10 is moved in the direction of closing by way of the case 18. FIG. 7A is a generalized drawing in plan view corresponding to FIG. 1B illustrating the upper part of the case 18, and FIG. 7B is a generalized drawing in sectional view corresponding to FIG. 1B illustrating the lower part of the case 18.

Here, when the case 18 is moved in the direction of arrow A based on the latch unit 28, the piston rod 44 is pushed into the cylinder 42 as illustrated in FIGS. 6A and 7A. The damping force of the damper 40 therefore comes to act on the case 18. Accordingly, the sliding door 10 is moved quietly in the direction of closing. When the sliding door 10 is completely closed, the sliding door 10 contacts with the door frame 12, but the noise of impact at that time is prevented.

Meanwhile, the sliding door 10 is moved in the direction of opening (direction opposite the direction of arrow A) from the state illustrated in FIGS. 7A and 7B. At this time, the latch unit 28 is moved by way of the sliding door 10 and the pin member 52, but the latch unit 28 is moved in the direction (direction of arrow A) opposing the impelling force of the tension spring 48, and the sliding door 10 comes to receive a proportional load. It is thereby made so that the sliding door 10 is not opened recklessly.

Also, the latch unit 28 moves, whereby the piston rod 44 is withdrawn from the cylinder 42. A so-called “resistance force” (damping force) generated when the piston moves in the cylinder 42 therefore comes to act on the latch unit 28.

Also, the latch unit 28 is moved by way of the pin member 52, and the catching piece 78 of the holding member 64 reaches the front end part of the rail 26, at which time the catching piece 78 is caught on the front end part of the rail 26, the front end part of the catching piece 78 is inserted into the catching hole 80, and the holding member 64 is projected outward through the window hole 60. In this state, the latch unit 28 is restricted from movement (locked state).

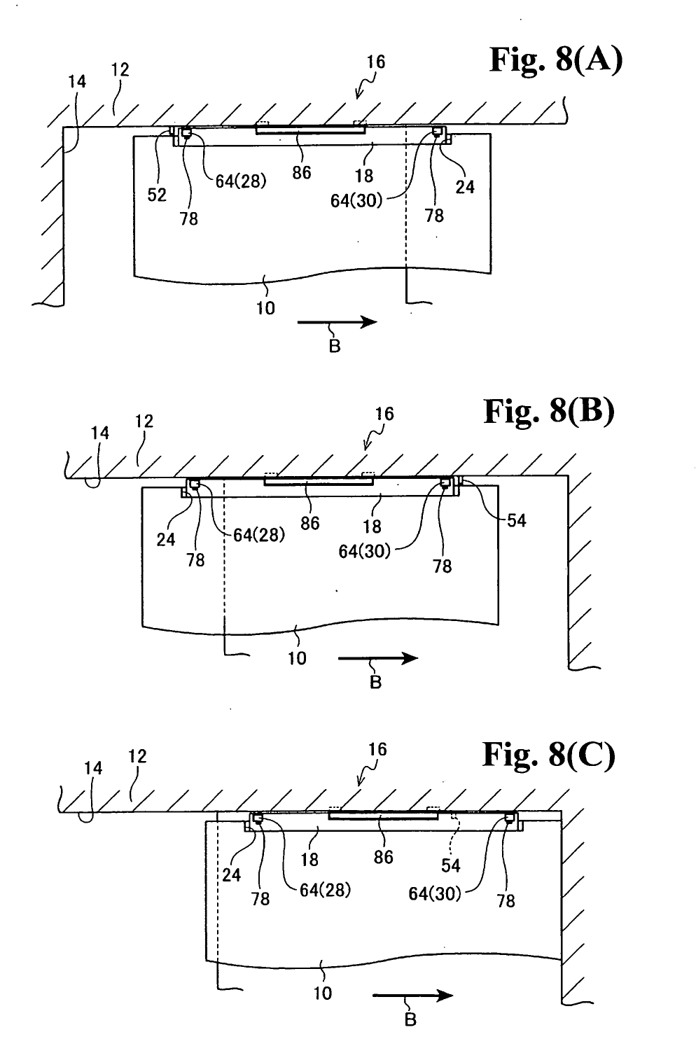

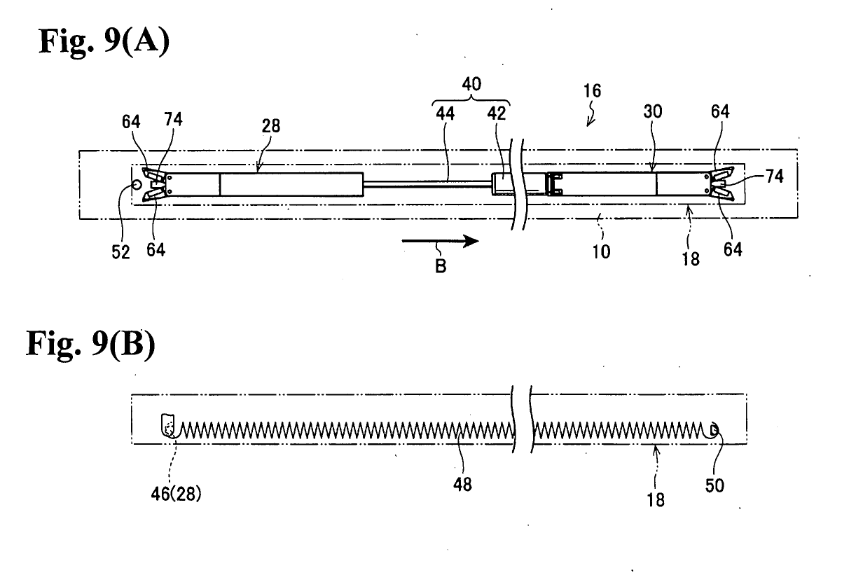

Also, the pin member 52 is released from the state of being caught with the holding member 64 as illustrated in FIG. 9A, but this state is a state in which elastic energy (impelling force) of the tension spring 48 is accumulated as illustrated in FIG. 9B. FIG. 9A is a generalized drawing in plan view corresponding to FIG. 8A illustrating the upper part of the case 18, and FIG. 9B is a generalized drawing in sectional view corresponding to FIG. 8A illustrating the lower part of the case 18.

In this state, as illustrated in FIGS. 8A and 8B, the resistance forces of the tension spring 48 and the damper 40 do not act when the sliding door 10 is moved in the direction of opening (direction of arrow B), and the sliding door becomes proportionally lighter.

Also, the sliding door 10 is further moved in the direction of opening (direction of arrow B), the guide piece (see FIG. 2) of the moving apparatus 16 passes by the pin member 54, and as illustrated in FIGS. 5A and 5B, the pin member 54 contacts with the rod 74 of the latch unit 30, and the rod 74 is pushed in the direction opposing the impelling force of the latch spring 76.

Also, the cam parts 72 of the holding members 64 are pushed wider by the movement of the contacting parts 74A provided on the rod 74, and are moved away from each other. The holding members 64 are thereby rotated on the support part 68 as a center, the holding members 64 close, the holding parts 70 are moved closer to each other, and the pin member 54 is held.

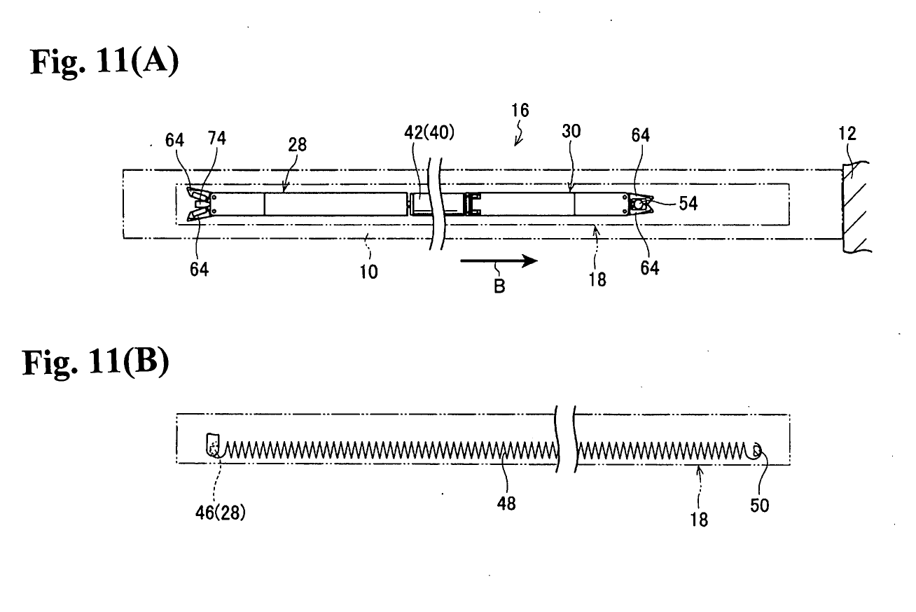

At this time, the front end part of the catching piece 78 illustrated in FIG. 4A comes out from the catching hole 80 (see FIG. 2), and the catching piece 78 is released (unlocked) from the state of being caught with the front end part of the rail 26. Also, as illustrated in FIGS. 10A and 11A, the case 18 is moved by way of the latch unit 30, whereby the piston rod 44 is pushed into the cylinder 42.

The damping force of the damper 40 therefore acts on the case 18 by way of the latch unit 30. FIG. 10A is a generalized drawing in plan view corresponding to FIG. 8B illustrating the upper part of the case 18, and FIG. 11A is a generalized drawing in plan view corresponding to FIG. 8C illustrating the upper part of the case 18.

Here, because the tension spring 48 is connected to the case 18 of the latch unit 28 as illustrated in FIGS. 10B and 11B, the impelling force of the tension spring 48 does not act on the latch unit 30 even when the latch unit 30 is unlocked. FIG. 10B is a generalized drawing in sectional view corresponding to FIG. 8B illustrating the lower part of the case 18, and FIG. 11B is a generalized drawing in sectional view corresponding to FIG. 8C illustrating the lower part of the case 18.

A moving apparatus was provided on a sliding door in the present mode of working above, but the moving apparatus may be provided on the side of the door frame. In this case, the pin member comes to be provided on the side of the sliding door. Also, a single-type sliding door was described in the present mode of working, but the latch unit may be applied in a double-type sliding door. In this case, two moving apparatuses are required. Furthermore, a sliding door that is moved in the horizontal direction was described here, but the latch unit may be applied in a sliding door that is moved in the vertical direction, and the latch unit may also be used in a drawer apparatus, or the like.

What is claimed is:

1. A latch device, comprising:
a pair of holding members provided with holding parts capable of holding a striker;
a support part for supporting said holding parts to be capable of moving closer and moving away;
contacted parts provided on said holding members and positioned on sides opposite said holding parts with said support part as reference;
a rod provided to be capable of moving between the pairs said holding parts and said contacted parts;
an impelling member for impelling said rod toward said holding parts; and
contacting parts projecting from an outer perimeter surface of said rod to contact said contacted parts so that said contacted parts are moved in a direction of moving away from each other and said holding parts are moved in a direction of moving closer to each other when the rod is moved in a direction opposing the impelling force of said impelling member.

2. The latch device according to claim 1, wherein an inclined cam surface for transforming an amount of movement of said rod into a rotational force for moving said holding parts closer is formed on said contacted part or said contacting part.

3. The latch device according to claim 1, wherein a distance from said support part to said holding part is made longer than a distance from the support part to a part of said contacted part contacted by said contacting part.

4. The latch device according to claim 1, wherein a projecting part projecting in the direction of moving away and to be caught in a hole part formed on a latch case, on which said support part is installed, in a state in which said striker is held by said holding part, is provided on an end part of said contacted part.
